(19) United States
(12) Patent Application Publication
(10) Pub. No.: US 2017/0278362 A1
(43) Pub. Date: Sep. 28, 2017

(54) INFORMATION PROCESSING DEVICE, INFORMATION PROCESSING METHOD, AND PROGRAM

(71) Applicant: NEC Corporation, Minato-ku, Tokyo (JP)

(72) Inventors: Mizuto SEKINE, Tokyo (JP); Akira YAJIMA, Tokyo (JP); Yuriko YASUDA, Tokyo (JP)

(73) Assignee: NEC Corporation, Minato-ku, Tokyo (JP)

(21) Appl. No.: 15/505,996

(22) PCT Filed: Jul. 16, 2015
(86) PCT No.: PCT/JP2015/070359

§ 371 Date: Feb. 23, 2017

(30) Foreign Application Priority Data
Sep. 19, 2014 (JP) 2014-190857

(51) Int. Cl. G07G 3/00; G06Q 20/20; G06K 9/00; A47F 9/04

(52) U.S. Cl. CPC G07G 3/003; A47F 9/047; G06Q 20/206; G06K 9/00771

(57) ABSTRACT

An information processing device (10) includes an image acquisition unit (110) that acquires an image obtained by capturing a vicinity of a merchandise self-checkout system, and a detection unit (120) that detects a presence or absence of a plurality of persons within a first area in the vicinity of the merchandise self-checkout system during a time period between a start and end of a merchandise self-checkout process based on the acquired image.

### TECHNICAL FIELD

The present invention relates to an information processing device, an information processing method, and a program.

### BACKGROUND ART

Stores are installed with merchandise self-checkout systems (so-called self-service point of sale (POS) terminals) for customers to perform self-checkout of merchandise (for example, reading the bar code attached to a target merchandise to be checked out). According to such a merchandise self-checkout system, an effect may be expected such as a reduction in costs, which would otherwise be necessary for checkout operators. On the other hand, since customers do not come face to face with store clerks, there is a problem in an increased risk of fraud being committed in a merchandise self-checkout process.

An example of a technique for preventing fraud is disclosed in, for example, Patent Document 1 mentioned below. A self-service POS disclosed in Patent Document 1 compares an image of merchandise during scanning with an image of the merchandise captured on an unchecked-out merchandise counter and an image of the merchandise captured on a checked-out merchandise counter, to thereby monitor that the merchandise self-checkout process is being appropriately performed by the customer.

### RELATED DOCUMENT

### Patent Document

[Patent Document 1] Japanese Patent Application Laid-Open Publication No. 2009-289222

### SUMMARY OF THE INVENTION

### Problem to be Solved by the Invention

Various frauds may be committed in a self-service POS terminal which may not be prevented by the technique of Patent Document 1 described above. In particular, frauds committed by multiple persons are very difficult to prevent.

The present invention provides a technique for preventing fraud in a self-service POS terminal with higher accuracy.

### Means for Solving the Problem

According to the present invention, there is provided an information processing device including:

an image acquisition unit that acquires an image obtained by capturing a vicinity of a merchandise self-checkout system; and

a detection unit that detects a presence or absence of a plurality of persons within a first area in the vicinity of the merchandis self-checkout system during a time period between a start and end of a merchandise self-checkout process based on the acquired image.

According to the invention, there is provided an information processing method performed by a computer, the method including the steps of:

acquiring an image obtained by capturing a vicinity of a merchandise self-checkout system; and

detecting a presence or absence of a plurality of persons within a first area in the vicinity of the merchandise self-checkout system during a time period between a start and end of a merchandise self-checkout process based on the acquired image.

According to the invention, there is provided a program causing a computer to function as:

an image acquisition unit that acquires an image obtained by capturing a vicinity of a merchandise self-checkout system; and

a detection unit that detects a presence or absence of a plurality of persons within a first area in the vicinity of the merchandise self-checkout system during a time period between a start and end of a merchandise self-checkout process based on the acquired image.

### Effect of the Invention

According to the invention, it is possible to prevent fraud in a self-service POS terminal with higher accuracy.

### BRIEF DESCRIPTION OF THE DRAWINGS

The above-described objects, other objects, features and advantages will be further apparent from the preferred embodiments described below, and the accompanying drawings as follows.

FIG. 1 is a schematic di illustrating a processing configuration of an information processing device according to a first exemplary embodiment.

FIG. 2 is a diagram illustrating an example of a shape of a first area.

FIG. 3 is a schematic diagram illustrating an example of a hardware configuration of the information processing device according to the first exemplary embodiment.

FIG. 4 is a flow chart illustrating a flow of processing of the information processing device according to the first exemplary embodiment.

FIG. 5 is a diagram illustrating an example of a predetermined partial area.

FIG. 6 is a flow chart illustrating a flow of processing of an information processing device according to a second exemplary embodiment.

FIG. 7 is a flow chart illustrating a flow of processing of an information processing device according to a modification example of the second exemplary embodiment.

FIG. 8 is a diagram illustrating an outline of processing of the information processing device according to the second exemplary embodiment.

FIG. 9 is a flow chart illustrating a flow of processing of an information processing device according to a third exemplary embodiment.

FIG. 10 is a flow chart illustrating a flow of processing of an information processing device according to a modification example of the third exemplary embodiment.

FIG. 11 is a schematic diagram illustrating a processing configuration of an information processing device according to a fourth exemplary embodiment.

FIG. 12 is a flow chart illustrating a flow of processing of the information processing device according to the fourth exemplary embodiment.

FIG. 13 is a schematic diagram illustrating a processing configuration of an information processing device according to a modification example of the fourth exemplary embodiment.

FIG. 14 is a schematic diagram illustrating a processing configuration of an information processing device according to a fifth exemplary embodiment.

FIG. 15 are diagrams illustrating a specific example of the vicinity of a position at which merchandise is scanned.

### DESCRIPTION OF EMBODIMENTS

Hereinafter, embodiments of the invention will be described with reference to the accompanying drawings. In all of the drawings, like reference numerals denote like components, and a description thereof will not be repeated.

### First Exemplary Embodiment

[Processing Configuration]

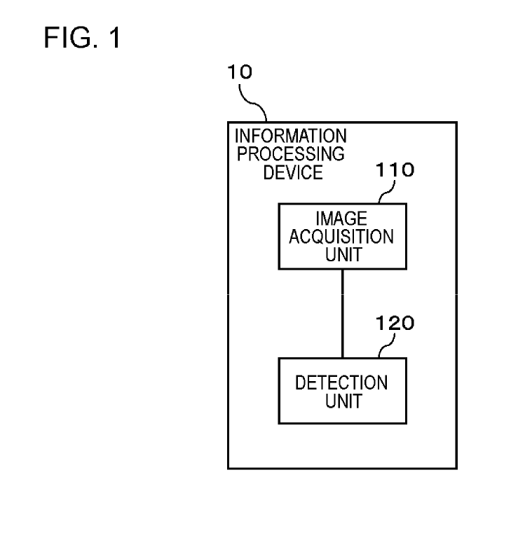

FIG. 1 is a schematic di illustrating a processing configuration of an information processing device 10 according to a first exemplary embodiment. The information processing device 10 may be a device which is communicably connected to a merchandise self-checkout system (hereinafter, referred to as a self-service POS terminal, not shown), or may be a self-service POS terminal itself. As illustrated in FIG. 1, the information processing device 10 of the present exemplary embodiment includes an image acquisition unit 110 and a detection unit 120.

The image acquisition unit 110 acquires an image obtained by capturing the vicinity of the self-service POS terminal. The image acquisition unit 110 acquires an image from an imaging unit (not shown) such as a charge coupled device (CCD) camera. The wording “vicinity of self-service POS terminal” means a range that partially includes at least a first area to be described later. The imaging unit is provided in, for example, the main body of the self-service POS terminal or a location such as the ceiling or wall of an area where the self-service POS terminal is installed, in order to monitor the self-service POS terminal.

The detection unit 120 detects a presence or absence of multiple persons in the first area in the vicinity of the self-service POS terminal during a time period between the start and end of a merchandise self-checkout process based on the acquired image. The detection unit 120 is capable of comparing the image acquired by the image acquisition unit 110 with a reference image (image in which a person is not captured), extracting a region including a difference between the images, and making inferences on each person who is present in the image from the size, shape, and color characteristics of the extracted region, and the like. In addition, the detection unit 120 is capable of extracting a region inferred to be a person from the image by using any of other known person detection algorithms or the like.

The wording “start of merchandise self-checkout process” means a certain timing of the start of a series of actions performed by a customer to checkout merchandise using a self-service POS terminal. However, there may be a certain time width for the timing of the “start of merchandise self-checkout process”. Examples of the timing include a timing at which the customer comes to stand in front of the self-service POS terminal, a timing at which unchecked-out merchandise is placed on the unchecked-out merchandise counter, a timing at which the reading of the bar code of the target merchandise to be checked out is started, and the like. The detection unit 120 can determine whether or not the customer has come to stand in front of the self-service POS terminal or whether the customer has placed unchecked-out merchandise on an unchecked-out merchandise counter by using, for example, a proximity sensor, a pressure sensitive sensor, or the like. The detection unit 120 may determine whether or not the customer has come to stand in front of the self-service POS terminal or whether or not unchecked-out merchandise has been correctly placed on the unchecked-out merchandise counter based on an image captured by an imaging unit. However, the timing of a “start of merchandise self-checkout process” is not limited to these examples.

Similarly, the wording “end of merchandise self-checkout process” means a certain timing of an end of a series of actions performed by a customer to check out merchandise using a self-service POS terminal. However, there may be a certain time width for the timing of the “end of merchandise self-checkout process”. Examples of the timing include a timing at which the customer presses a button for confirming purchase of each piece of target merchandise to be checked out which has been read by the self-service POS terminal, a timing at which a receipt is issued, a timing at which a bag containing the purchased merchandise is lifted off from the counter after payment has been made for the merchandise, and the like. The timing of the “end of merchandise self-checkout process” is not limited to these examples.

The first area is an area including at least a position where fraud monitoring performed by a monitoring camera or a monitoring person (store clerk or the like) may possibly be blocked due to the presence of multiple persons in the area. The first area is appropriately set in accordance with a relationship or the like between the position of a monitoring camera or a position where a monitoring person is normally present (for example, the installed position of a monitoring person's terminal, or the like) and the position of the self-service POS terminal. For example, the first area is defined by an imaging range of an imaging unit provided for the purpose of monitoring the self-service POS terminal. In this case, the detection unit 120 sets the entire image obtained from the imaging unit as the first area and detects a presence or absence of multiple persons in the first area. The invention is not limited thereto, and the first area may be defined as a partial region of an image captured by the imaging unit. In this case, the detection unit 120 may identify the first area in the image captured by the imaging unit by marking the floor to indicate the first area, for example, by changing the color of the floor of the first area in advance. In addition, the detection unit 120 may be configured to be capable of holding a parameter indicating a position on the image which corresponds to the first area in advance and identifying the first area by the parameter. In a case where multiple imaging units are provided with respect to each self-service POS terminal, the parameter is held in each imaging unit.

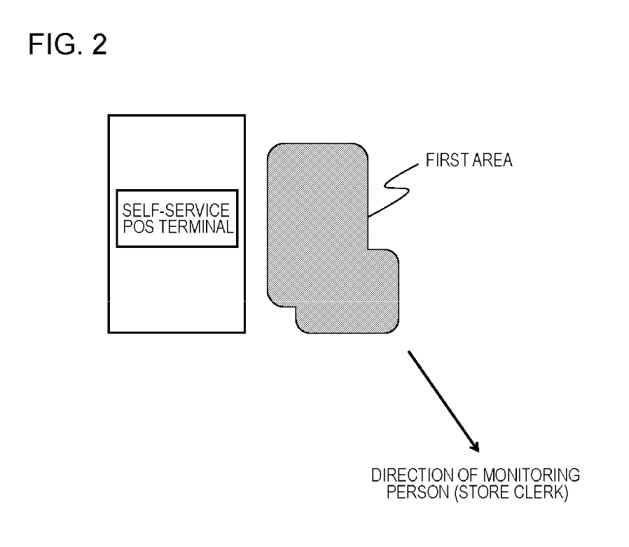

A specific example of the shape of a first area will be described with reference to FIG. 2. FIG. 2 is a diagram illustrating an example of the shape of the first area. The shape of the first area is not particularly limited but is preferably projected in the direction of a monitoring person (store clerk), as illustrated in FIG. 2. According to the first area having a shape as illustrated in FIG. 2, it is possible to accurately detect a state of a person, who is different from the person operating the self-service POS terminal, standing at a position which may form a blind spot for the monitoring person. In addition, in the example illustrated in FIG. 2, the first area is one continuous area, but the invention is not limited thereto. The first area may be constituted by multiple areas that are separated from each other.

[Hardware Configuration]

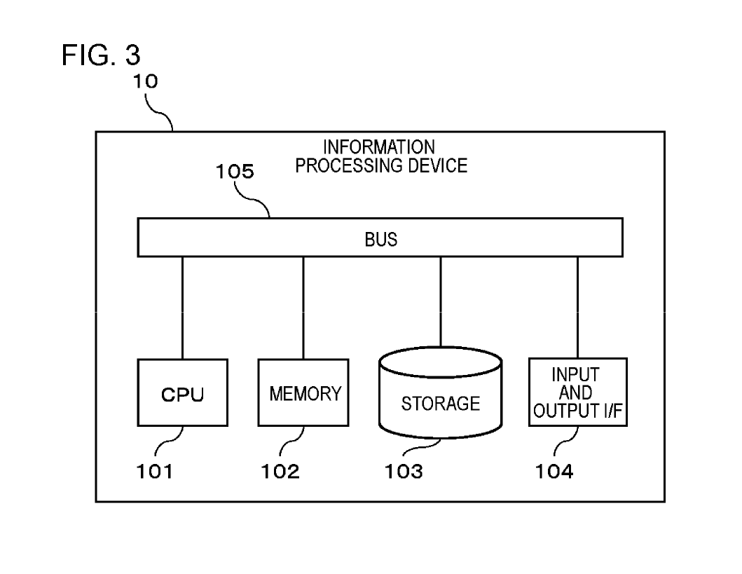

FIG. 3 is a schematic diagram illustrating an example of a hardware configuration of the information processing device according to the first exemplary embodiment. As illustrated in FIG. 3, the information processing device 10 includes a central processing unit (CPU) 101, a memory 102, a storage 103, an input and output interface 104, and the like. A bus 105 is a data transmission path for transmitting and receiving data to and from the CPU 101, the memory 102, the storage 103, and the input and output interface 104. However, a method of connecting the CPU 101 and the like to each other is not limited to bus connection. The CPU 101 is a computational processing apparatus such as a central processing unit (CPU) or a graphics processing unit (GPU). The memory 102 is a memory such as a random access memory (RAM) or a read only memory (ROM). The storage 103 is a storage device such as a hard disk, a solid state drive (SSD), or a memory card. In addition, the storage 103 may be a memory such as a RAM or a ROM.

The input and output interface 104 is used to transmit and receive data between the information processing device 10 and an external device or the like. For example, in a case where the information processing device 10 acquires an image of the vicinity of a self POS terminal from the external device (for example, an imaging device such as a security camera), the information processing device 10 is connected to the external device through the input and output interface 104. It should be noted that there are various methods of connecting the information processing device 10 to the external device through the input and output interface 104. For example, the connection is a bus connection through a bus line (for example, a universal serial bus (USB) line), network connection through a network line, or the like. It should be noted that, the network line may be a wireless line or a wired line.

The storage 103 stores programs for implementing the function of the information processing device 10. Specifically, the storage stores program modules for implementing the functions of the image acquisition unit 110 and the detection unit 120. The CPU 101 executes the program modules to thereby implement the functions of the image acquisition unit 110 and the detection unit 120. Here, the CPU 101 may or may not read out the modules on the memory 102 to execute the modules.

It should be noted that the hardware configuration of the information processing device 10 is not limited to the configuration illustrated in FIG. 3. For example, the program modules may be stored in the memory 102. In this case, the information processing device 10 may not include the storage 103. In addition, in a case where the information processing device 10 is a self-service POS terminal, a display device, an input and output device, a reading device, and the like are further connected thereto through the input and output interface 104. The display device is a device, such as a liquid crystal display (LCD) or a cathode ray tube (CRT) display, which displays a screen corresponding to drawing data processed by the CPU 101 or a GPU (not shown). The input device is a device that receives an input by a user's operation, and is implemented as, for example, a hardware button unit, a touch sensor, or the like. The display device and the input device may be integrated with each other to be implemented as a touch panel. The reading device is a camera including a lens, an imaging element, and the like, and captures a still image or a moving image of target merchandise to be checked out. In addition, the reading device may be a symbol reading device, such as a bar code reader including a light source, a light receiving element, and the like. In addition, in a case where the information processing device 10 is a self-service POS terminal, at least one imaging device may further be connected thereto through the input and output interface 104. The imaging device is a monitoring camera that includes a lens, an imaging element, and the like and captures an image of the vicinity of the self-service POS terminal.

### Operational Example

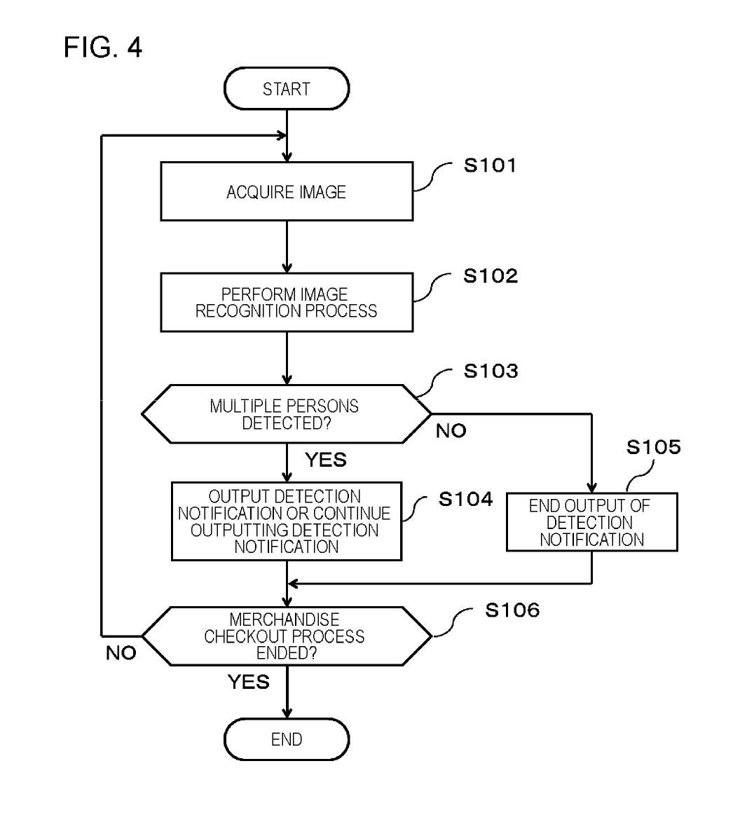

An operational example or the information processing device 10 according to the present exemplary embodiment will be described with reference to FIG. 4. FIG. 4 is a flow chart illustrating a flow of processing of the information processing device 10 according to the first exemplary embodiment. Processes to be described below are performed in accordance with the above-described “timing at which it is determined that merchandise self-checkout process has been started”.

When a merchandise self-checkout process is started, the image acquisition unit 110 acquires an image of the vicinity of a self-service POS terminal from an imaging unit (S101). The detection unit 120 performs image recognition process on the acquired image, and calculates the number of persons included in the image (S102). The detection unit 120 determines whether or not multiple persons are detected in the acquired image (S103). In a case where multiple persons are detected in the acquired image (S103: YES), the detection unit 120 outputs a notification (detection notification) indicating the detection of the multiple persons to, for example, a monitoring person's terminal, or the like or continues outputting a detection notification in a state where the detection notification is already being output (S104). The detection notification of S104 includes information for specifying the self-service POS terminal of which vicinity has been detected with the multiple persons (for example, the information is specific identification information allocated to each self-service POS terminal, or the like). On the other hand, in a case where multiple persons have not been detected from the acquired image (S103: NO), the detection unit 120 does not output a detection notification, or the detection unit 120 ends the output of the detection notification in a state where the detection notification is already being output (S105). These processes are repeated until the above-described “timing at which it is determined that merchandise self-checkout process has been ended” (S106).

### Operations and Effects of First Exemplary Embodiment

A person intending to commit fraud in general hopes to prevent the fraud from being discovered. In hopes of preventing the fraud from being discovered, the fraud may include multiple persons arranged to stand in the vicinity of a self-service POS terminal, forming a blind spot unobservable from the surroundings. Here, the information processing device 10 of the present exemplary embodiment detects the presence of multiple persons in a first area during a time period between the start and end of a merchandise self-checkout process. In other words, the information processing device 10 of the present exemplary embodiment detects a state in which a blind spot unobservable from the surroundings is intentionally formed. In a case where it is detected that multiple persons are present in the first area during a time period between the start and end of the merchandise self-checkout process, a detection notification is output to the outside (for example, to a monitoring person's terminal). The notification allows a monitoring person to recognize a state in which there is the possibility of fraud in the self-service POS terminal based on the detection notification. Thereby, an effect may be expected of accurately preventing fraud in the self-service POS terminal by heightening the vigilance of a monitoring person against a customer using the self-service POS terminal.

### Second Exemplary Embodiment

An information processing device 10 of the present exemplary embodiment has the same configuration as that of the information processing device 10 of the first exemplary embodiment except for the following respects.

[Processing Configuration]

A detection unit 120 of the present exemplary embodiment further detects a presence or absence of a person in a predetermined partial area within a first area. For example, the detection unit 120 may identify the predetermined partial area in an image captured by an imaging unit by setting the predetermined partial area to be identifiable within the first area in advance, for example, by attaching a particular mark to the predetermined partial area within the first area. The invention is not limited thereto. A parameter indicating a position on the image corresponding to the predetermined partial area may be set in the detection unit 120 in advance, and the detection unit 120 may be configured to identify the predetermined partial area in an acquired image by using the parameter.

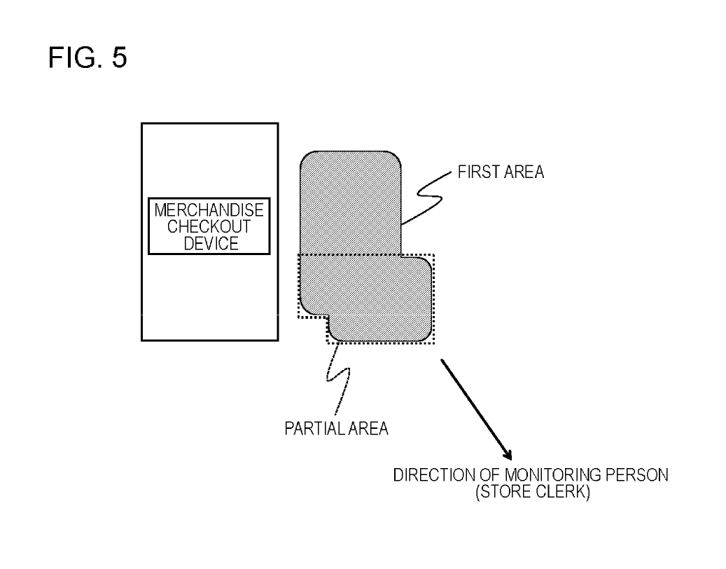

The predetermined partial area is an area, within the first area, between a position where a person operating a self-service POS terminal is normally assumed to be present and the position of a monitoring person. The predetermined partial area is an area in which, when a person is present in the partial area, a blind spot is formed for the monitoring person, due to the person. The predetermined partial area is set as illustrated in, for example, FIG. 5. FIG. 5 is a diagram illustrating an example of a predetermined partial area. In the example of FIG. 5, an area surrounded by a dotted line in the first area is the predetermined partial area. In the example of FIG. 5, a monitoring person is present in the direction of an arrow, and a blind spot of the monitoring person may be formed due to a person who is present in the predetermined partial area. In this case, for example, when a person is present in the predetermined partial area, the monitoring person is unable to view the position at which merchandise is scanned by a person operating a self-service POS terminal. The merchandise scanning timing is a timing with a high risk of any type of fraud being committed. Thus, if the monitoring person has no view of the merchandise scanning position, there is concern that the monitoring person would not notice an act of fraud committed at the merchandise scanning timing.

Consequently, the detection unit 120 of the present exemplary embodiment is configured to detect a presence or absence of a person forming a blind spot with respect to a monitoring person, as described above.

### Operational Example

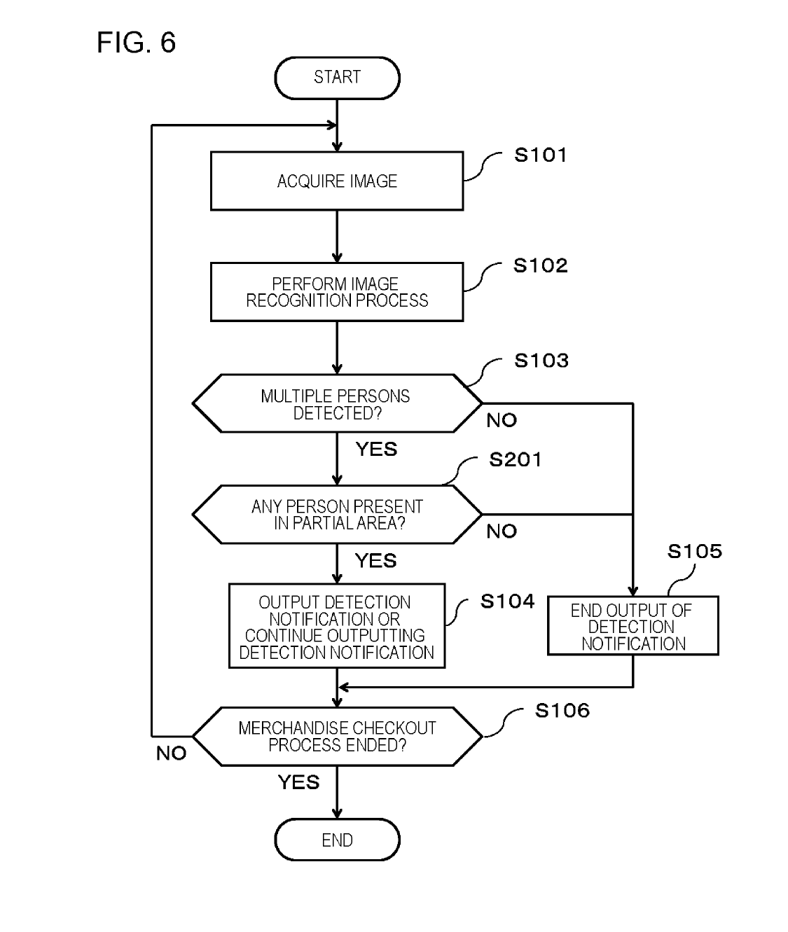

An operational example of the information processing device 10 according to the present exemplary embodiment will be described with reference to FIG. 6. FIG. 6 is a flow chart illustrating a flow of processing of the information processing device 10 according to the second exemplary embodiment. Hereinafter, processes different from those in the first exemplary embodiment will be mainly described.

In a case where the determination result of S103 is “YES”, that is, in a case where multiple persons are detected by image recognition, the detection unit 120 further determines whether or not at least one person among the detected plurality of persons is present in a predetermined partial area (S201). In a case where a person is present in the predetermined partial area (S201: YES), the detection unit 120 outputs a detection notification, for example, to a monitoring person's terminal, or the like, or continues outputting a detection notification in a state where the detection notification is already being output. On the other hand, in a case where no person is present in the predetermined partial area (S201: NO), the detection unit does not output any detection notification or the detection unit ends the output of a detection notification in a state where the detection unit is already being output.

### Operations and Effects of Second Exemplary Embodiment

As described above, in the present exemplary embodiment, in a case where it is detected that multiple persons are present within a first area, it is further detected whether or not a person is present in a predetermined partial area of the first area. Here, the predetermined partial area is an area where a blind spot may be formed for a monitoring person due to a person in a case where the person is present within the predetermined partial area. That is, according to the present exemplary embodiment, it is possible to detect a state in which there is a high risk of fraud in a self-service POS terminal, caused by a state such as the person operating the self-service POS terminal being hidden from a monitoring person's field of vision due to another person. Moreover, by a notification based on the detection result, it is possible to heighten the vigilance of the monitoring person against a customer using the self-service POS terminal and to accurately prevent fraud in the self-service POS terminal.

### Modification Example of Second Exemplary Embodiment

In the second exemplary embodiment, a detection notification is output when both “presence of multiple persons within first area” and “presence of a person within a predetermined area” are detected. In the present modification example, a description will be given of an example in which, when “presence of multiple persons within first area” is detected, different output detection notifications are output in accordance with whether or not “presence of a person within a predetermined area” is detected.

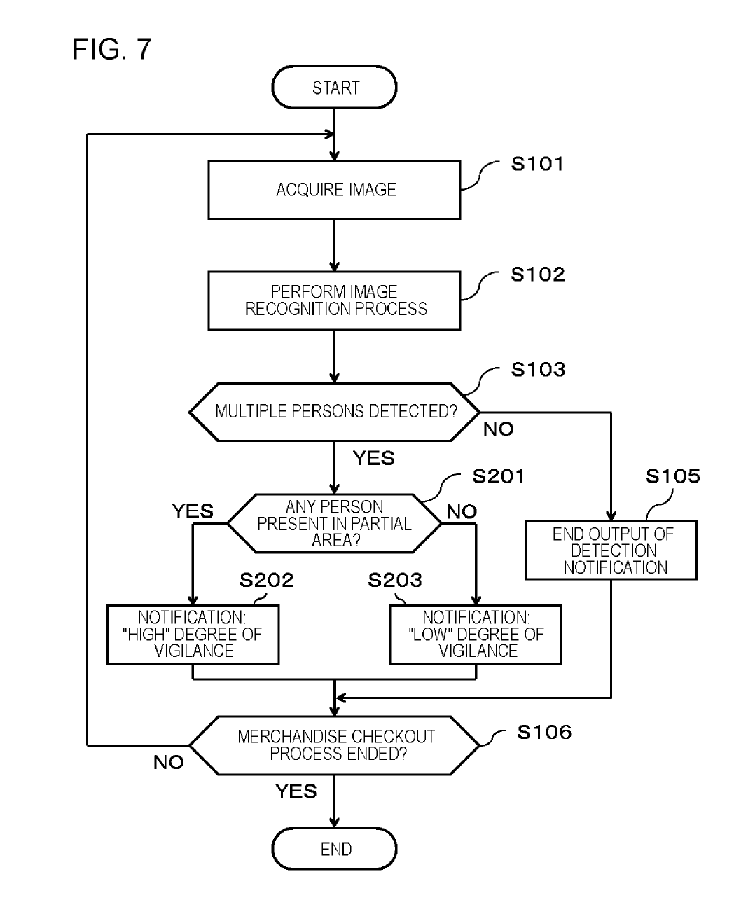

FIG. 7 is a flow chart illustrating a flow of processing of the information processing device 10 according to the modification example of the second exemplary embodiment. Hereinafter, differences from the flow chart of FIG. 6 will be mainly described.

As a result of the determination of S201, in a case where it is detected that a person is present in a predetermined partial area, the detection unit 120 outputs a detection notification of a “high” degree of vigilance (S202). On the other hand, as a result of the determination of S201, in a case where no person is detected to be present in a predetermined partial area, the detection unit 120 outputs a detection notification of a “low” degree of vigilance (S203).

As described above, according to the present modification example, in a case where it is detected that multiple persons are present within a first area, it is possible to output a notice to a monitoring person with a changed degree of vigilance against a customer using the corresponding self-service POS terminal based on a presence or absence of a person in a predetermined partial area. Thereby, a monitoring person is able to recognize a customer who should be closely watched, and thus an effect may be expected of preventing fraud in a self-service POS terminal with higher accuracy.

### Third Exemplary Embodiment

An information processing device 10 of the present exemplary embodiment has the same configuration as those of the information processing devices 10 of the above-described exemplary embodiments except for the following respects.

[Processing Configuration]

A detection unit 120 of the present exemplary embodiment further detects whether or not a second area in the vicinity of a self-service POS terminal is captured in an image acquired by an image acquisition unit 110. For example, a parameter indicating a position corresponding to a second area on an image captured by an imaging unit is set in the detection unit 120 in advance. The detection unit 120 identifies the second area in an image acquired using the parameter set in advance. In addition, a state where “non-capture of second area” as mentioned herein may be a state where the entire second area is not captured or may be a state where the second area is not captured at a fixed ratio or more.

The wording “second area” as used herein refers to an area including a position that may block the monitoring performed by an imaging unit provided in order to monitor a self-service POS terminal. The second area may be defined as, for example, an area in the vicinity of a position over which a customer holds merchandise to be scanned by a self-service POS terminal. The wording “area in the vicinity of merchandise scanning position” is an area with an extremely high risk of fraud where self-checkout is performed by the customer himself or herself using a self-service POS terminal. In the area in the vicinity of a merchandise scanning position, there is a possibility that an act of fraud is committed, such as, making the unscanned merchandise look like it has already been scanned by the customer, or, during scanning of a certain piece of merchandise, exchanging the certain piece of scanned merchandise with a piece of unscanned merchandise that has been hidden close by the customer. In this case, the detection unit 120 further detects whether or not the area in the vicinity of a merchandise scanning position (for example, a merchandise reading unit) is captured in an image.

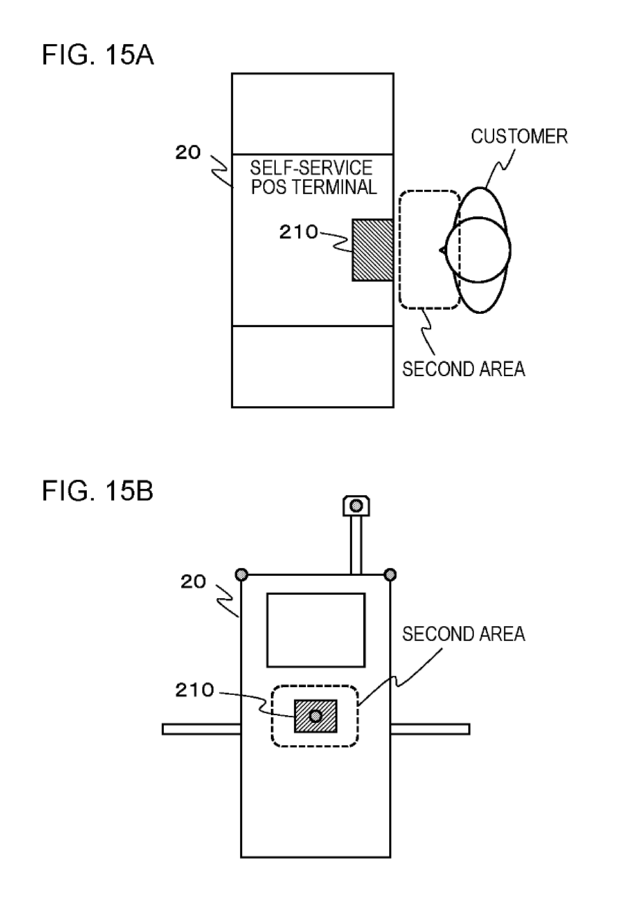

A specific example of “the vicinity of merchandise scanning position” will be described with reference to FIG. 15. FIG. 15 are diagrams illustrating a specific example of the vicinity of a merchandise scanning position. FIG. 15(a) illustrates the self-service POS terminal 20 when seen from the front. FIG. 15(b) illustrates the self-service POS terminal 20 when seen from the above. For example, “the vicinity of merchandise scanning position” may be set as a range as indicated by a dotted line in each of FIGS. 15(a) and 15(b). As illustrated in FIG. 15, “the vicinity of merchandise scanning position” may be determined based on the position of a merchandise reading unit 210, as a range in which a customer using the self-service POS terminal 20 moves during the scanning of merchandise.

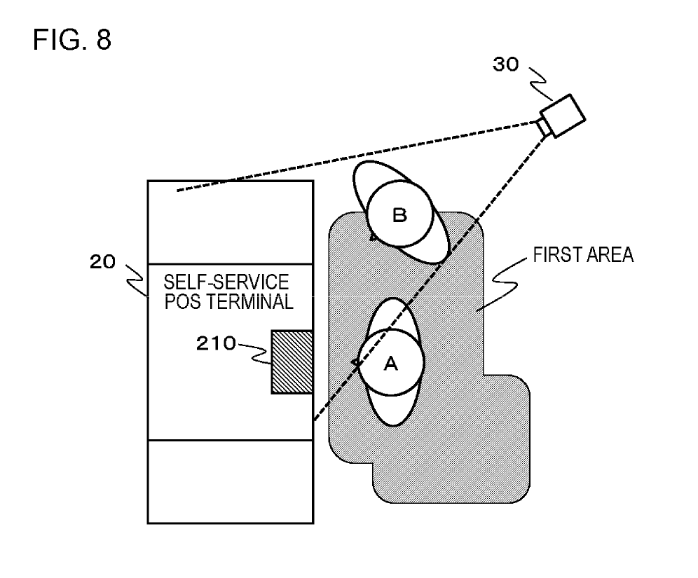

FIG. 8 is a diagram illustrating an outline of processing of the information processing device according to the second exemplary embodiment. FIG. 8 illustrates an example in which a monitoring camera 30 installed above the self-service POS terminal 20 captures an image of the vicinity of the self-service POS terminal 20. A person “A” denotes a person operating the self-service POS terminal 20, and a person “B” denotes a person not operating the self-service POS terminal 20 but is present in the vicinity of the self-service POS terminal 20. In addition, dotted lines in FIG. 8 indicate an imaging range of the monitoring camera 30. As illustrated in FIG. 8, the monitoring camera 30 is provided so as to include in its imaging range the vicinity of a merchandise scanning position, that is, the vicinity of the merchandise reading unit 210. In the example of FIG. 8, both the person “A” and the person “B” are present in a first area, and the person B is present at a position where the vicinity of the merchandise reading unit 210 is hidden when seen from the monitoring camera 30. That is, in a state as illustrated in FIG. 8, an area (second area) in the vicinity of the merchandise reading unit 210 is not captured in an image captured by the monitoring camera 30. The detection unit 120 of the present exemplary embodiment detects such a state. Although not shown in the drawing, the monitoring camera 30 may be provided in the self-service POS terminal 20 to include an area in the vicinity of the merchandise reading unit 210 as its imaging range. Similarly, in this case, the detection unit 120 determines whether or not an area in the vicinity of the merchandise reading unit 210 is captured in an image captured by the monitoring camera 30 provided in the self-service POS terminal 20. In addition, multiple monitoring cameras 30 may be provided in the self-service POS terminal 20. In this case, it is determined whether or not an area in the vicinity of the merchandise reading unit 210 is captured in each of the monitoring cameras 30, and any non-capture of the area in the vicinity of the merchandise reading unit 210 is detected in at least any one of the monitoring cameras.

### Operational Example

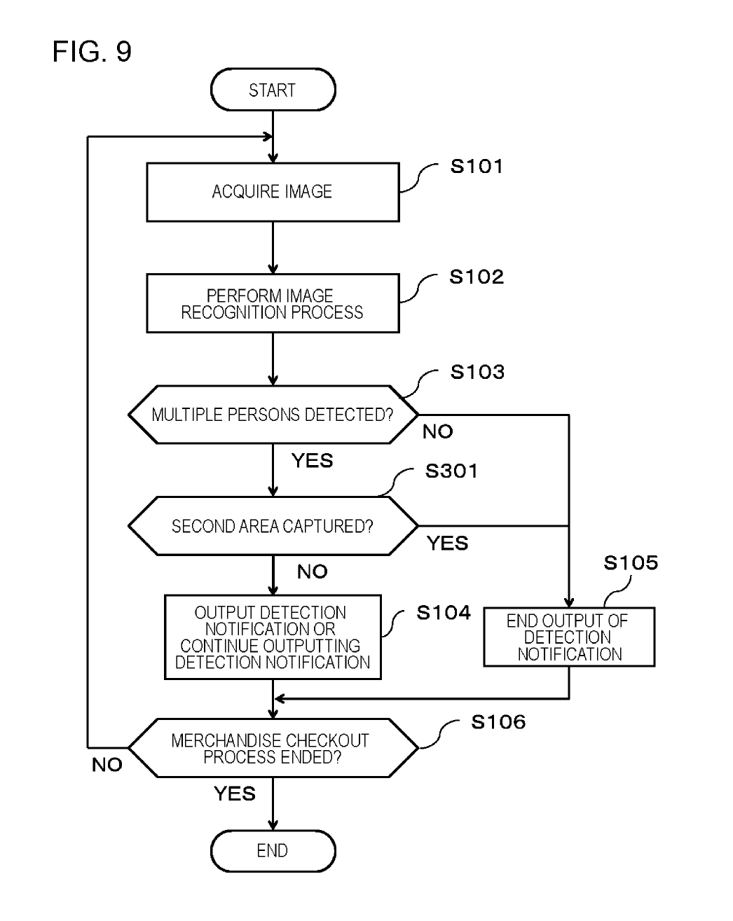

An operational example of the information processing device 10 according to the present exemplary embodiment will be described with reference to FIG. 9. FIG. 9 is a flow chart illustrating a flow of processing of the information processing device 10 according to the third exemplary embodiment. Hereinafter, processes different from those in other exemplary embodiments will be mainly described.

In a case where the determination result of S103 is “YES”, that is, in a case where multiple persons are detected by image recognition, the detection unit 120 determines whether or not a second area is captured in the image acquired in S101 (S301). In a case where the second area is not captured (S301: NO), the detection unit 120 outputs, for example, a detection notification to a monitoring person's terminal, or the like, or continues outputting a detection notification in a state where the detection notification is already being output. On the other hand, in a case where the second area is captured (S301: YES), the detection unit outputs no detection notification, or if a detection notification is already being output, terminates the output thereof.

### Operations and Effects of Third Exemplary Embodiment

As described above, in the present exemplary embodiment, in a case where multiple persons are present in a first area, it is further detected whether or not a second area in the vicinity of a self-service POS terminal is captured. Here, the second area is an area in the vicinity of a merchandise scanning position of the self-service POS terminal. That is, according to the present exemplary embodiment, it is possible to detect a state in which there is a high fraud risk, caused by such a state as hiding of the merchandise scanning position from view. It is possible to heighten the vigilance of a monitoring person against a customer using the self-service POS terminal by a notification based on a detection result and to prevent fraud in the self-service POS terminal with higher accuracy.

### Modification Example of Third Exemplary Embodiment

In the second exemplary embodiment, a detection notification is output when both “presence of multiple persons within first area” and “non-capture of second area” are detected. In the present modification example, when “presence of multiple persons within first area” is detected, different output notifications are output in accordance with whether or not “non-capture of second area” is further detected.

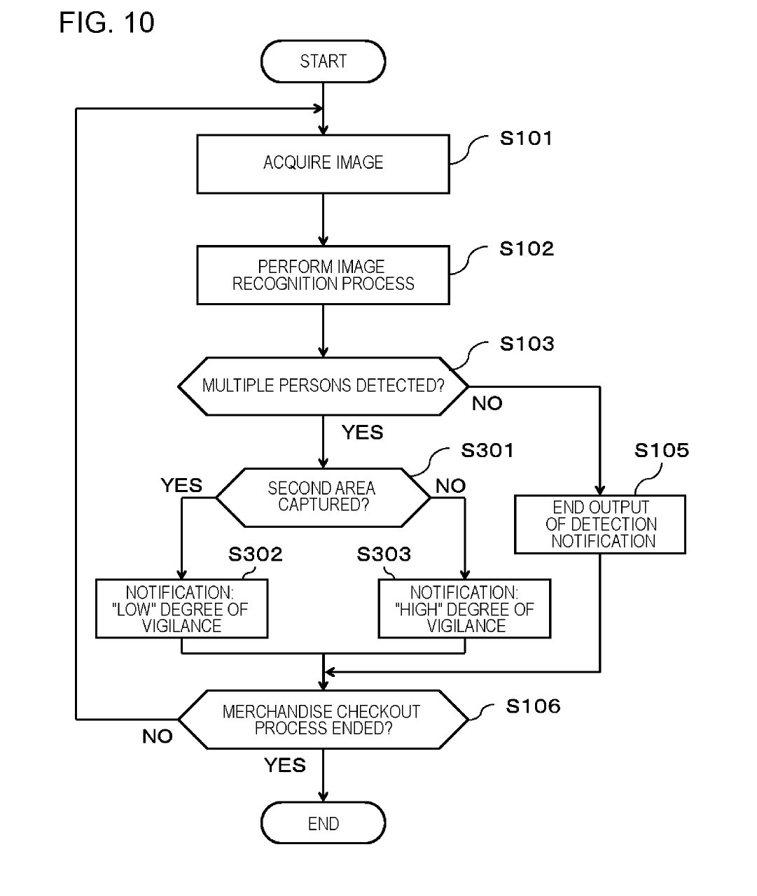

FIG. 10 is a flow chart illustrating a flow of processing of the information processing device 10 according to a modification example of the third exemplary embodiment. Hereinafter, differences from the flow chart of FIG. 9 will be mainly described.

As a result of the determination of S301, in a case where it is detected that a second area is captured, the detection unit 120 outputs a “low” vigilance detection notification (S302). On the other hand, as result of the determination of S301, in a case where non-capture of the second area is not detected, the detection unit 120 outputs a “high” vigilance detection notification (S303).

As described above, according to the present modification example, in a case where multiple persons are present within a first area, it is possible to output a notice to a monitoring person with varied degrees of vigilance against a customer using the corresponding self-service POS terminal based on whether or not a second area is captured in an acquired image. Thereby, a customer requiring higher alert by the monitoring person may be identified, and thus an effect may be expected of preventing fraud in a self-service POS terminal with higher accuracy.

### Fourth Exemplary Embodiment

The information processing device 10 of the present exemplary embodiment has the same configuration as those of the information processing devices 10 of the above-described exemplary embodiments except for the following respects.

[Processing Configuration]

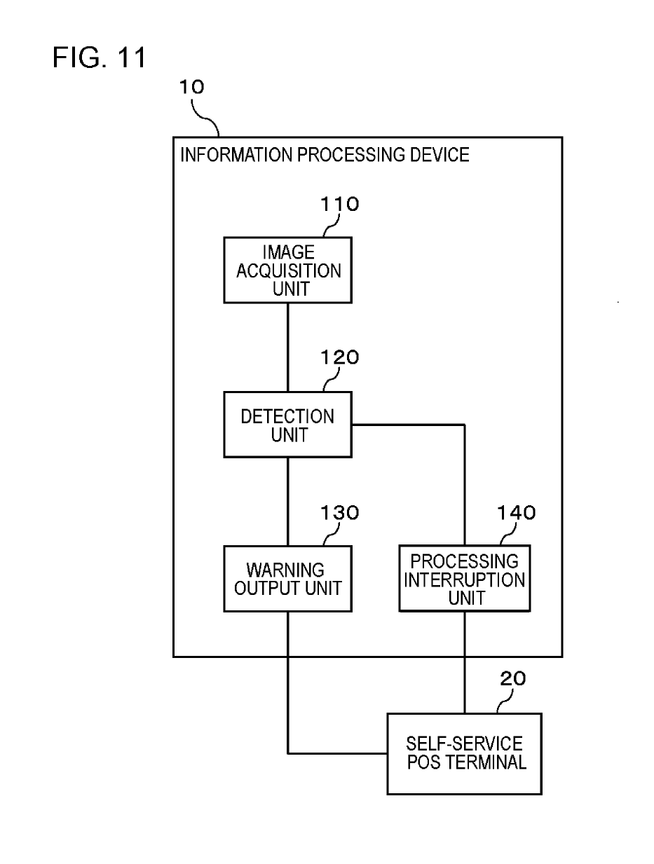

FIG. 11 is a schematic diagram illustrating a processing configuration of an information processing device 10 according to a fourth exemplary embodiment. As illustrated in FIG. 11, the information processing device 10 of the present exemplary embodiment further includes a warning output unit 130 and a processing interruption unit 140. The warning output unit 130 and the processing interruption unit 140 are implemented by a CPU 101 executing a program module for implementing the function of the warning output unit 130 and a program module for implementing the function of the processing interruption unit 140, which are stored in a storage 103, similar to the first exemplary embodiment.

The warning output unit 130 outputs warning information in accordance with a detection result of a detection unit 120. The warning information is information for prompting multiple persons to keep out of a first area, and is notified to multiple persons present in the first area in the vicinity of the self-service POS terminal 20. Specific examples of the warning information include a warning message such as “scanning by one person only”, a predetermined warning sound, and the like. However, the warning information is not limited to these examples. The warning output unit 130 notifies the persons using the self-service POS terminal 20 of the warning information through a display unit (not shown) or a sound output unit (not shown) of the self-service POS terminal 20.

The processing interruption unit 140 interrupts a merchandise self-checkout process in the self-service POS terminal 20, based on detection results by the detection unit 120 for a time period from the output of warning information to the elapse of a predetermined time. The processing interruption unit 140 starts up a timer (not shown) by using, for example, the output of warning information by the warning output unit 130 as a trigger, and determines whether or not a predetermined time, which is held in advance, has elapsed. However, a method of managing a predetermined time by the processing interruption unit 140 is not limited thereto. In addition, the predetermined time may be set or changed to an appropriate value in the information processing device 10.

### Operational Example

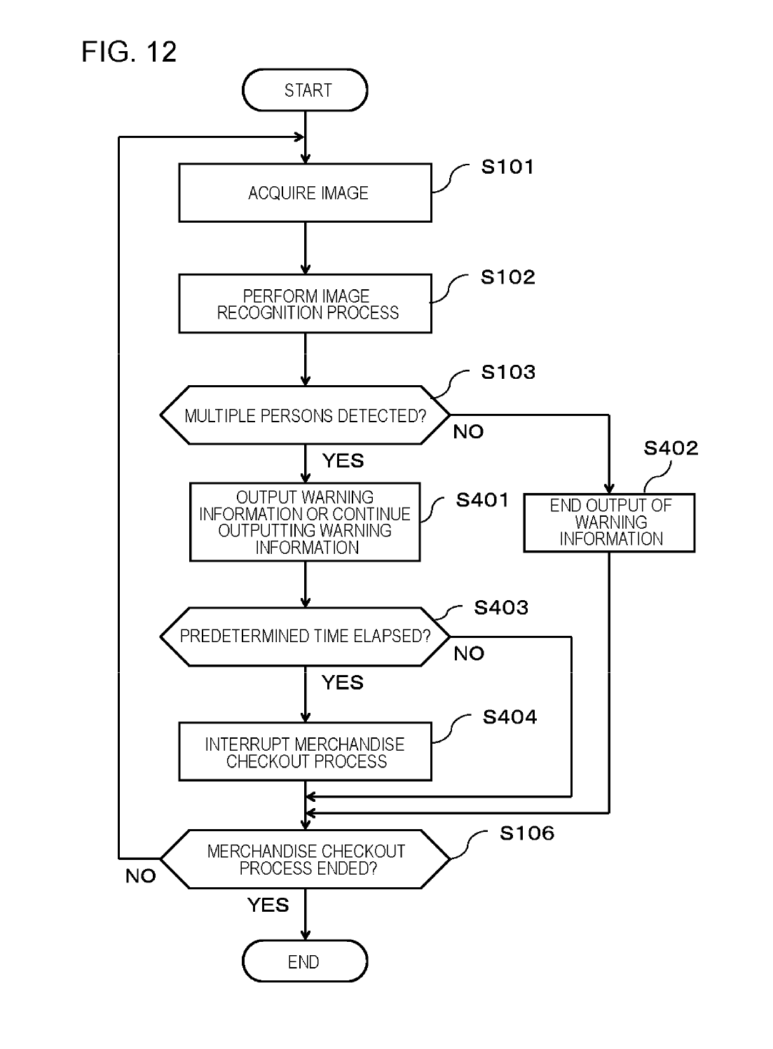

An operational example of the information processing device 10 according to the present exemplary embodiment will be described with reference to FIG. 12. FIG. 12 is a flow chart illustrating a flow of processing of the information processing device 10 according to the fourth exemplary embodiment. Hereinafter, processes different from those in other exemplary embodiments will be mainly described.

In a case where “presence of multiple persons in first area” is detected by the detection unit 120 in the determination of S103, the warning output unit 130 outputs warning information from the display unit or the sound output unit of the self-service POS terminal 20 (S401). The warning output unit 130 may be configured to output warning information in a case where “presence of a person in predetermined partial area” is further detected by the detection unit 120 as described in the second exemplary embodiment, in addition to “presence of multiple persons in first area”. In addition, the warning output unit 130 may be configured to output warning information in a case where “non-capture of second area” is further detected by the detection unit 120 as described in the third exemplary embodiment, in addition to “presence of multiple persons in first area”. On the other hand, in a case where “presence of multiple persons in first area” is not detected by the detection unit 120 in the determination of S103, the warning output unit 130 ends the output of warning information (S402).

In a case where warning information is output, the processing interruption unit 140 starts up a timer and determines whether or not a predetermined time has elapsed from the output of the warning information based on the value of the timer (S403). In a case where the predetermined time has not elapsed from the output of the warning information (S403: NO), the processing proceeds to S106, and the determination of whether the predetermined time has elapsed is continued while the warning information is still being output. Here, the predetermined time managed in S403 is reset in a case where the output of the warning information is ended in S402. In a case where the predetermined time has elapsed from the output of the warning information (S403: NO), the processing interruption unit 140 outputs an instruction for interrupting the merchandise self-checkout process to the self-service POS terminal 20, to interrupt the merchandise self-checkout process in the self-service POS terminal 20 (S404).

### Operations and Effects of Fourth Exemplary Embodiment

As described above, in the present exemplary embodiment, warning information for preventing multiple persons from entering a first area is output to a person using the self-service POS terminal 20, in accordance with a result of the detection performed by the detection unit 120. Thereby, it is possible to prompt the person using the self-service POS terminal 20 to prevent multiple persons from entering the first area. In other words, it is possible to eliminate a state in which there is the possibility of fraud. Thereby, an effect may be expected of preventing fraud in the self-service POS terminal 20.

In addition, in the present exemplary embodiment, in a case where the presence of multiple persons is detected by the detection unit 120 and a state where multiple persons are present within a first area is continued regardless of the output of warning information to the self-service POS terminal 20, the merchandise self-checkout process in the self-service POS terminal 20 is interrupted. Thereby, according to the present exemplary embodiment, it is possible to prevent fraud in the self-service POS terminal 20 with high accuracy by preventing customers from continuing the merchandise self-checkout process under a state in which there is the possibility of fraud.

### Modification Example of Fourth Exemplary Embodiment

In the present modification example, a description is given of an example in which, when the presence of multiple persons is detected by the detection unit 120, the warning output unit 130 first outputs warning information to a monitoring person's terminal (specific terminal) and then outputs warning information to the self-service POS terminal 20 in accordance with an instruction from the monitoring person who has seen the warning information.

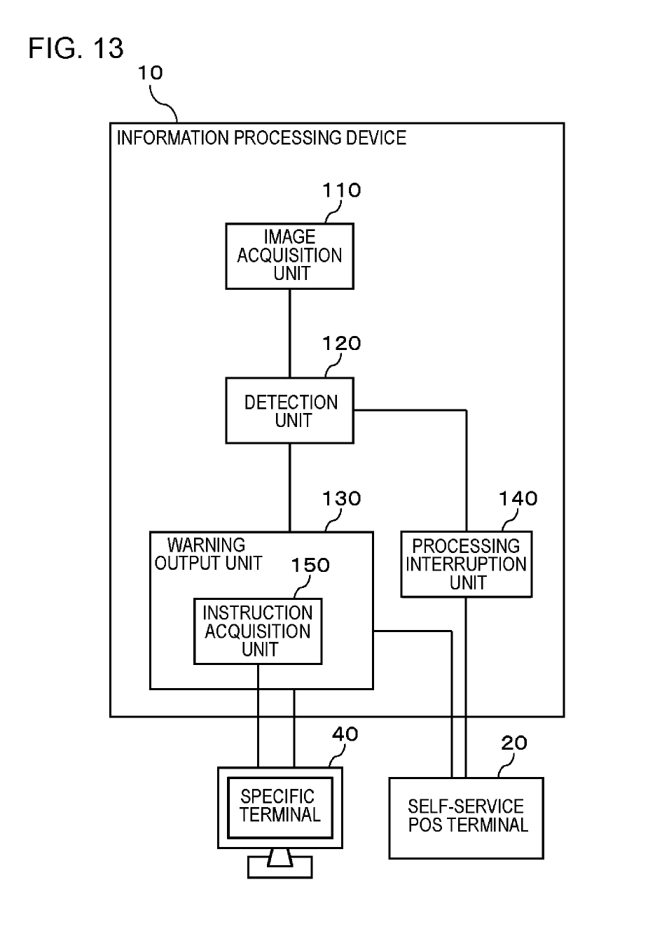

FIG. 13 is a schematic diagram illustrating a processing configuration of the information processing device 10 according to the modification example of the fourth exemplary embodiment. As illustrated in FIG. 13, the information processing device 10 of the present modification example further includes an instruction acquisition unit 150. The instruction acquisition unit 150 acquires instruction information from a specific terminal 40. The instruction information acquired from the specific terminal 40 includes an instruction for outputting warning information to the self-service POS terminal 20. The instruction acquisition unit 150 is implemented by the CPU 101 executing a program module for implementing the function of the instruction acquisition unit 150 stored in the storage 103, similar to the first exemplary embodiment.

The warning output unit 130 of the present modification example outputs warning information to the specific terminal 40. The monitoring person checks the output and then monitors the state of the self-service POS terminal 20 being the warning target, and inputs instruction information through an input unit (not shown) of the specific terminal 40 in a case where the monitoring person determines that warning information should be output to the self-service POS terminal 20. Thereby, the instruction information is output to the instruction acquisition unit 150.

As described above, it is possible to obtain the same effects as those in the above-described fourth exemplary embodiment also in the present modification example. In addition, warning information is first output to a monitoring person, and thus it is possible to reduce a possibility that the warning information is erroneously notified to a customer.

### Fifth Exemplary Embodiment

An information processing device 10 of the present exemplary embodiment has the same configuration as those of the information processing devices 10 of the above-described exemplary embodiments except for the following respects.

[Processing Configuration]

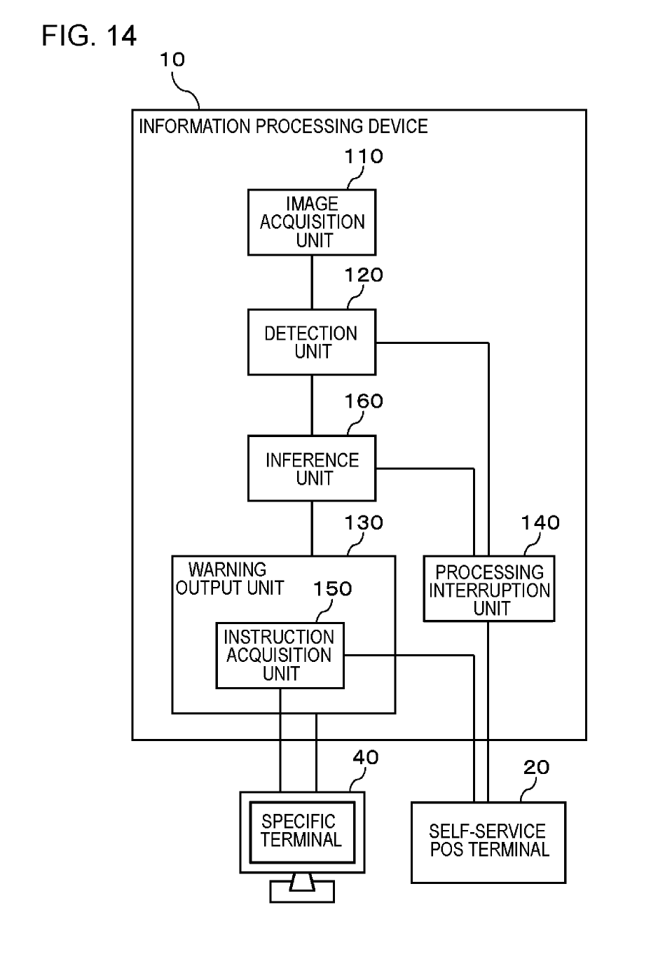

FIG. 14 is a schematic diagram illustrating a processing configuration of the information processing device 10 according to the fifth exemplary embodiment. As illustrated in FIG. 14, the information processing device 10 of the present exemplary embodiment further includes an inference unit 160.

The inference unit 160 infers attributes of a person who is present in a first area based on an image acquired by an image acquisition unit 110. Here, the attributes of the person include, for example, an age group, gender, physical characteristics (for example, tall or short height), and the like. The inference unit 160 infers the attributes of the person by using a known image processing technique. The inference unit 160 is implemented by a CPU 101 executing a program module for implementing the function of the inference unit 160 stored in a storage 103, similar to the first exemplary embodiment.

A warning output unit 130 of the present exemplary embodiment determines whether to output warning information or determines an output destination of warning information based on the attributes of the person to be inferred by the inference unit 160.

For example, in a case where it is detected that two persons are present in a first area, it is assumed that the inference unit 160 infers the attributes of one person as “female, normal height” and the attribute of the other person as “short”. In this case, the two persons present in the first area may be considered to be a mother and her child. In this case, although there are multiple persons present in the first area, there is a possibility that the child is present only to be beside the mother, and thus the warning output unit 130 determines that, for example, there is no need to output warning information. In this case, the warning output unit 130 may output warning information to a specific terminal 40 before outputting warning information to the self-service POS terminal 20, and may wait for the determination of a monitoring person. At this time, the warning output unit 130 outputs the warning information to the specific terminal 40 inclusive of information indicating the attributes of the persons inferred by the inference unit 160.

As another example, it is assumed that the inference unit 160 estimates that both the two persons in the first area have attributes of “male, tall”. In this case, the two persons present in the first area are considered to be two adult male persons. In this case, there is no situation such as the above-described example of the combination of the mother and the child, and the warning output unit 130 determines that there is a higher possibility that an act of fraud may be committed than in at least the above-described example and outputs warning information to the specific terminal 40. In this case, the warning output unit 130 may output warning information to the self-service POS terminal 20 without outputting warning information to the specific terminal 40 and waiting for the determination of a monitoring person.

In addition, the processing interruption unit 140 of the present exemplary embodiment reduces or extends the predetermined time between the output of warning information and the interruption of the merchandise self-checkout process based on the attributes of the persons inferred by the inference unit 160. Specifically, in the above-described example of the combination of the mother and the child, the processing interruption unit 140 extends the predetermined time between the output of the warning information and the interruption of the merchandise self-checkout process. On the other hand, in the above-described example of the two adult male persons, the processing interruption unit 140 reduces the predetermined time between the output of the warning information and the interruption of the merchandise self-checkout process.

### Operations and Effects of Fifth Exemplary Embodiment

As described above, in the present exemplary embodiment, attributes of multiple persons present in a first area are inferred by the inference unit 160, and whether to output warning information or an output destination of the warning information is determined based on the attributes. In other words, in the present exemplary embodiment, the degree of the risk of fraud is determined based on a combination of the attributes of the persons which are inferred by the inference unit 160, and a process of outputting warning information is performed in accordance with the degree of the risk. Thereby, according to the present exemplary embodiment, it is possible to prevent warning information from being excessively displayed to general customers using the self-service POS terminal 20.

As described above, the exemplary embodiments of the invention have been described with reference to the accompanying drawings, but are illustrative of the invention. It is also possible to adopt various configurations other than the above-described configurations.

For example, in the exemplary embodiments, the information processing device 10 may be configured to detect the presence of a person at a position blocking the view of the monitoring person or a monitoring camera even if multiple persons are not detected in a first area, and to output a detection notification or warning information which indicates the detection. For example, the information processing device 10 may be configured to detect a state where a person is present in a partial area even when only one person is present in the first area, or a state where a second area is blocked from view of a monitoring camera or the like, and to output a detection notification or warning information.

In addition, in the plural flow charts used in the above description, plural steps (processes) are described in order. However, the execution order of the processes performed in each exemplary embodiment is not limited to the order described. In each exemplary embodiment, it is possible to change the order of the steps illustrated in the drawing in a range in which no problem is caused in terms of the contents. In addition, the above-described exemplary embodiments may be combined with each other in a range in which the contents thereof do not conflict with each other.

Hereinafter, an example of a reference configuration will be appended.

1. An information processing device including:

an image acquisition unit that acquires an image obtained by capturing a vicinity of a merchandise self-checkout system; and

a detection unit that detects a presence or absence of a plurality of persons within a first area in the vicinity of the merchandise self-checkout system during a time period between a start and end of a merchandise self-checkout process based on the acquired image.

2. The information processing device according to 1,

wherein the detection unit further detects a presence or absence of a person in a predetermined partial area within the first area.

3. The information processing device according to 1 or 2,

wherein the detection unit further detects whether or not a second area in the vicinity of the merchandise self-checkout system is captured in the acquired image.

4. The information processing device according to 3,

wherein the second area includes an area in a vicinity of a merchandise scanning position in the merchandise self-checkout system.

5. The information processing device according to any one of 1 to 4, further including

a warning output unit that outputs warning information in accordance with a result of the detection performed by the detection unit.

6. The information processing device according to 5, further including

an instruction acquisition unit that acquires instruction information from a specific terminal,

wherein the warning output unit causes the warning information to be displayed on a display unit of the specific terminal, and, after the warning information has been displayed, causes the warning information to be displayed on a display unit of the merchandise self-checkout system based on the instruction information acquired by the instruction acquisition unit.

7. The information processing device according to 5 or 6, further including

an inference unit that infers an attribute of a person present within the first area based on the acquired image,

wherein the warning output unit determines whether or not to output the warning information or determines an output destination of the warning information based on the inferred attribute of the person.

8. The information processing device according to any one of 5 to 7, further including

a processing interruption unit that interrupts the merchandise self-checkout process based on a state of the detection performed by the detection unit during a time period between output of the warning information and elapse of a predetermined time.

9. The information processing device according to 7, further including

a processing interruption unit that interrupts the merchandise self-checkout process based on a state of the detection performed by the detection unit during a time period between output of the warning information and elapse of a predetermined time,

wherein the processing interruption unit reduces or extends the predetermined time based on the inferred attribute of the person.

10. An information processing method performed by a computer, the method including the steps of:

acquiring an image obtained by capturing a vicinity of a merchandise self-checkout system; and

detecting a presence or absence of a plurality of persons within a first area in the vicinity of the merchandise self-checkout system during a time period between a start and end of a merchandise self-checkout process based on the acquired image.

11. The information processing method according to 10, further including the step performed by the computer of

further detecting a presence or absence of a person in a predetermined partial area within the first area.

12. The information processing method according to 10 or 11, further including the step performed by the computer of

further detecting whether or not a second area in the vicinity of the merchandise self-checkout system is captured in the acquired image.

13. The information processing method according to 12,

wherein the second area includes an area in a vicinity of a merchandise scanning position in the merchandise self-checkout system.

14. The information processing method according to any one of 10 to 13, further including the step performed by a computer of

outputting warning information in accordance with a result of the detection.

15. The information processing method according to 14, further including the steps performed by the computer of:

causing the warning information to be displayed on a display unit of the specific terminal;

acquiring instruction information from the specific terminal; and

causing the warning information to be displayed on a display unit of the merchandise self-checkout system based on the instruction information acquired after the warning information has been displayed on the display unit of the specific terminal.

16. The information processing method according to 14 or 15, further including the steps performed by the computer of:

inferring an attribute of a person present within the first area based on the acquired image; and

determining whether to output the warning information or determining an output destination of the warning information based on the inferred attribute of the person.

17. The information processing method according to any one of 14 to 16, further including the step performed by the computer of

interrupting the merchandise self-checkout process based on a state of the detection between output of the warning information and elapse of a predetermined time.

18. The information processing method according to 16, further including the steps performed by the computer of:

reducing or extending the predetermined time based on the inferred attribute of the person; and

interrupting the merchandise self-checkout process based on a state of the detection between output of the warning information and elapse of a predetermined time.

19. A program causing a computer to function as:

an image acquisition unit that acquires an image obtained by capturing a vicinity of a merchandise self-checkout system; and

a detection unit that detects a presence or absence of a plurality of persons within a first area in the vicinity of the merchandise self-checkout system during a time period between a start and end of a merchandise self-checkout process based on the acquired image.

20. The program according to 19,

wherein the detection unit further detects a presence or absence of a person in a predetermined partial area within the first area.

21. The program according to 19 or 20,

wherein the detection unit further detects whether or not a second area in the vicinity of the merchandise self-checkout system is captured in the acquired image.

22. The program according to 21,

wherein the second area includes an area in a vicinity of a merchandise scanning position in the merchandise self-checkout system.

23. The program according to any one of 19 to 22, causing the computer to further function as

a warning output unit that outputs warning information in accordance with a result of the detection performed by the detection unit.

24. The program according to 23, causing the computer to further function as

an instruction acquisition unit that acquires instruction information from a specific terminal,

wherein the warning output unit causes the warning information to be displayed on a display unit of the specific terminal, and

causes the warning information to be displayed on a display unit of the merchandise self-checkout system based on the instruction information acquired by the instruction acquisition unit after the warning information has been displayed on the display unit of the specific terminal.

25. The program according to 23 or 24, causing the computer to further function as

an inference unit that infers an attribute of a person present within the first area based on the acquired image,

wherein the warning output unit determines whether to output the warning information or determines an output destination of the warning information based on the inferred attribute of the person.

26. The program according to any one of 23 to 25, causing the computer to further function as

a processing interruption unit that interrupts the merchandise self-checkout process based on a state of the detection performed by the detection unit during a time period between output of the warning information and elapse of a predetermined time.

27. The program according to 25, causing the computer to further function as

a processing interruption unit that reduces or extends a predetermined time based on the inferred attribute of the person and terminates the merchandise self-checkout process based on a state of the detection performed by the detection unit during a time period between output of the warning information and elapse of the predetermined time.

The application is based on Japanese Patent Application No. 2014-190857 filed on Sep. 19, 2014, the content of which is incorporated herein by reference.

What is claimed is:

1. An information processing device comprising:
an image acquisition unit that acquires an image obtained by capturing a vicinity of a merchandise self-checkout system; and
a detection unit that detects a presence or absence of a plurality of persons within a first area in the vicinity of the merchandise self-checkout system during a time period between a start and end of a merchandise self-checkout process based on the acquired image.

2. The information processing device according to claim 1,
wherein the detection unit further detects a presence or absence of a person in a predetermined partial area within the first area.

3. The information processing device according to claim 1,
wherein the detection unit further detects whether or not a second area in the vicinity of the merchandise self-checkout system is captured in the acquired image.

4. The information processing device according to claim 3,
wherein the second area includes an area in a vicinity of a merchandise scanning position in the merchandise self-checkout system.

5. The information processing device according to claim 1, further comprising a warning output unit that outputs warning information in accordance with a result of the detection performed by the detection unit.

6. The information processing device according to claim 5, further comprising an instruction acquisition unit that acquires instruction information from a specific terminal,
wherein the warning output unit
causes the warning information to be displayed on a display unit of the specific terminal, and
after the warning information has been displayed, causes the warning information to be displayed on a display unit of the merchandise self-checkout system based on the instruction information acquired by the instruction acquisition unit.

7. The information processing device according to claim 5, further comprising an inference unit that infers an attribute of a person present within the first area based on the acquired image,
wherein the warning output unit determines whether or not to output the warning information or determines an output destination of the warning information based on the inferred attribute of the person.

8. The information processing device according to claim 5, further comprising a processing interruption unit that terminates the merchandise self-checkout process based on a state detected by the detection unit during a time period between output of the warning information and elapse of a predetermined time.

9. The information processing device according to claim 7, further comprising a processing interruption unit that interrupts the merchandise self-checkout process based on a state of the detection performed by the detection unit during a time period between output of the warning information and elapse of a predetermined time,
wherein the processing interruption unit reduces or extends the predetermined time based on the inferred attribute of the person.

10. An information processing method performed by a computer, the method comprising the steps of:
acquiring an image obtained by capturing a vicinity of a merchandise self-checkout system; and
detecting a presence or absence of a plurality of persons within a first area in the vicinity of the merchandise self-checkout system during a time period between a start and end of a merchandise self-checkout process based on the acquired image.

11. A non-transitory computer readable medium storing a program causing a computer to function as:
an image acquisition unit that acquires an image obtained by capturing a vicinity of a merchandise self-checkout system; and
a detection unit that detects a presence or absence of a plurality of persons within a first area in the vicinity of the merchandise self-checkout system during a time period between a start and end of a merchandise self-checkout process based on the acquired image.
